(19) United States
(12) Patent Application Publication
(10) Pub. No.: US 2022/0269883 A1
(43) Pub. Date: Aug. 25, 2022

(54) METHODS, APPARATUSES, DEVICES AND STORAGE MEDIA FOR PREDICTING CORRELATION BETWEEN OBJECTS INVOLVED IN IMAGE

(71) Applicant: SENSETIME INTERNATIONAL PTE. LTD., Singapore (SG)

(72) Inventors: Bairun WANG, Singapore (SG); Xuesen Zhang, Singapore (SG); Chunya LIU, Singapore (SG); Jinghuan CHEN, Singapore (SG); Shuai Yi, Singapore (SG)

(21) Appl. No.: 17/361,960

(22) Filed: Jun. 29, 2021

Related U.S. Application Data
(63) Continuation of application No. PCT/IB2021/055006, filed on Jun. 8, 2021.

(30) Foreign Application Priority Data
Feb. 22, 2021 (SG) 10202101743P

(51) Int. Cl. G06K 9/00; G06K 9/64; G06K 9/46; G06K 9/62

(52) U.S. Cl. CPC G06K 9/00362; G06K 9/64; G06K 9/4642; G06K 9/6256

(57) ABSTRACT

The present disclosure provides methods, apparatuses, devices and storage media for predicting correlation between objects involved in an image. According to a method, a first object and a second object involved in an acquired image are detected, where the first object and the second object represent different body parts. First weight information of the first object with respect to a target region and second weight information of the second object with respect to the target region are determined. The target region corresponds to a surrounding box for a combination of the first object and the second object. A weighted-processing is performed on the target region respectively based on the first weight information and the second weight information to obtain a first weighted feature and a second weighted feature of the target region. A correlation between the first object and the second object within the target region is predicted based on the first weighted feature and the second weighted feature.

### CROSS-REFERENCE TO RELATED APPLICATION

The present disclosure is a continuation application of International Application No. PCT/IB2021/055006 filed on Jun. 8, 2021, which claims priority to Singapore Patent Application No. 10202101743P filed on Feb. 22, 2021, the entire contents of which are incorporated herein by reference in their entireties.

### TECHNICAL FIELD

The present disclosure relates to a computer technology, and in particular, relates to methods, apparatuses, devices and storage media for predicting correlation between objects involved in an image.

### BACKGROUND

A technology, intelligent video analysis, can help us to understand statuses of objects in a physical space and their relations with each other. In a scenario of applying the intelligent video analysis, it is expected to identify a person based on one or more parts of his body which are appeared in a video.

In particular, a correlation of a body part with respect to a personnel identity may be identified through some intermediate information. For example, the intermediate information may indicate an object which is of a relatively definite correlation with respect to both the body part and the personnel identity. As a specific example, when it is expected to determine the personnel identity of which a hand is detected in an image, a face that is correlated with the hand (that is, the face and the hand are correlated with each other and they are named as correlated objects) and indicates the personnel identity may be utilized to realize the determination. In this example, the correlated objects may indicate two objects which both belong to a third object or have an identical identity information attribute. When two body parts are correlated objects of each other, it can be considered that the two body parts belong to one person.

By correlating the body parts involved in an image, it can further help to analyze a multi-person scenario, including the behavior and status of individuals and the relationship between multiple persons.

### SUMMARY

In view of the above, the present disclosure discloses at least one method of predicting correlation between objects involved in an image, including: detecting a first object and a second object involved in an acquired image, where the first object and the second object represent different body parts; determining first weight information of the first object with respect to a target region and second weight information of the second object with respect to the target region; where the target region corresponds to a surrounding box for a combination of the first object and the second object; performing weighted-processing the target region respectively based on the first weight information and the second weight information to obtain first weighted features and second weighted features of the target region; and predicting a correlation between the first object and the second object within the target region based on the first weighted features and the second weighted features.

In some embodiments, the method further includes: determining, based on a first bounding box for the first object and a second bounding box for the second object, a box that covers the first bounding box and the second bounding box but has no intersection with the first bounding box and the second bounding box as the surrounding box; or, determining, based on the first bounding box for the first object and the second bounding box for the second object, a box that covers the first bounding box and the second bounding box and is externally connected with the first bounding box and/or the second bounding box as the surrounding box.

In some embodiments, determining the first weight information of the first object with respect to the target region and the second weight information of the second object with respect to the target region includes: performing regional feature extracting on a region corresponding to the first object to determine a first feature map of the first object; performing regional feature extracting on a region corresponding to the second object to determine a second feature map of the second object; obtaining the first weight information by adjusting the first feature map to a preset size, and obtaining the second weight information by adjusting the second feature map to the preset size.

In some embodiments, performing the weighted-processing on the target region respectively based on the first weight information and the second weight information to obtain the first weighted feature and the second weighted feature of the target region includes: performing regional feature extracting on the target region to determine a feature map of the target region; performing a convolution operation, with a first convolution kernel that is constructed based on the first weight information, on the feature map of the target region to obtain the first weighted feature; and performing a convolution operation, with a second convolution kernel that is constructed based on the second weight information, on the feature map of the target region to obtain the second weighted feature.

In some embodiments, predicting the correlation between the first object and the second object within the target region based on the first weighted feature and the second weighted feature includes: predicting the correlation between the first object and the second object within the target region based on the first weighted feature, the second weighted feature, any one or more of the first object, the second object, and the target region.

In some embodiments, predicting the correlation between the first object and the second object within the target region based on the first weighted feature, the second weighted feature, and any one or more of the first object, the second object, and the target region includes: obtaining a spliced feature by performing feature splicing on the first weighted feature, the second weighted feature, and respective regional features of any one or more of the first object, the second object, and the target region; and predicting the correlation between the first object and the second object within the target region based on the spliced feature.

In some embodiments, the method further includes: determining, based on a prediction result for the correlation between the first object and the second object within the target region, correlated objects involved in the image.

In some embodiments, the method further includes: combining respective first objects and respective second objects detected from the image to generate a plurality of combinations, where each of the combinations includes one first object and one second object; and determining, based on the prediction result for the correlation between the first object and the second object within the target region, correlated objects involved in the image includes: determining a correlation prediction result for each of the plurality of combinations, where the correlation prediction result includes a correlation prediction score; selecting a current combination from respective combinations in a descending order of the correlation prediction scores of the respective combinations; and for the current combination: counting, based on the determined correlated objects, second determined objects that are correlated with the first object in the current combination and first determined objects that are correlated with the second object in the current combination; determining a first number of the second determined objects and a second number of the first determined objects; and in response to that the first number does not reach a first preset threshold and the second number does not reach a second preset threshold, determining the first object and the second object in the current combination as correlated objects involved in the image.

In some embodiments, selecting the current combination from the respective combinations in the descending order of the correlation prediction scores of the respective combinations includes: selecting, from the combinations whose correlation prediction scores reach a preset score threshold, the current combination in the descending order of the correlation prediction scores.

In some embodiments, the method further includes: outputting a detection result of the correlated objects involved in the image.

In some embodiments, the first object includes a face object; and the second object includes a hand object.

In some embodiments, the method further includes: training, based on a first training sample set, a target detection model; where the first training sample set contains training samples with first annotation information; and where the first annotation information includes a bounding box for the first object and a bounding box for the second object; and training, based on a second training sample set, the target detection model and a correlation prediction model jointly; where the second training sample set contains training samples with second annotation information; and where the second annotation information includes the bounding box for the first object, the bounding box for the second object, and annotation information of the correlation between the first object and the second object; where the target detection model is configured to detect the first object and the second object involved in the image, and the correlation prediction model is configured to predict the correlation between the first object and the second object involved in the image.

The present disclosure also provides an electronic device, including: at least one processor; and one or more memories coupled to the at least one processor and storing programming instructions for execution by the at least one processor to perform the method of predicting correlation between objects involved in an image illustrated according to any one of the foregoing embodiments.

The present disclosure also provides a non-transitory computer-readable storage medium coupled to at least one processor and storing programming instructions for execution by the at least one processor to execute the method of predicting correlation between objects involved in an image illustrated according to any one of the foregoing embodiments.

In the above solutions, a first weighted feature and a second weighted feature of a target region are obtained by performing weighted-processing on the target region respectively based on first weight information of a first object with respect to the target region and second weight information of a second object with respect to the target region. Then, a correlation between the first object and the second object within the target region is predicted based on the first weighted feature and the second weighted feature.

Thus, on one hand, during predicting the correlation between a first object and a second object, feature information contained in the target region that is useful for predicting the correlation is introduced, and thereby improving an accuracy of the prediction result. On the other hand, during predicting the correlation between the first object and the second object, by a weighting mechanism, feature information contained in the target region that is useful for predicting the correlation is strengthened while useless feature information is weakened, and thereby improving the accuracy of the prediction result.

It should be understood that the above general description and the following detailed description are only exemplary and explanatory, and are not intended to limit the present disclosure.

### BRIEF DESCRIPTION OF THE DRAWINGS

The drawings, which are employed during describing the embodiments or the related technologies, will be briefly introduced to explain the technical solutions provided by one or more embodiments of the present disclosure or by the related art more clearly. It is obvious that, the drawings in the following description illustrate only some examples described by one or more embodiments of the present disclosure, and based on these drawings, those of ordinary skill in the art may obtain other drawings without creative work.

FIG. 1 is a method flowchart illustrating a method of predicting correlation between objects involved in an image according to the present disclosure.

FIG. 2 is a schematic flowchart illustrating a method of predicting correlation between objects involved in an image according to the present disclosure.

FIG. 3 is a schematic flowchart illustrating a target-detecting according to the present disclosure.

FIG. 4a is an example illustrating a surrounding box according to the present disclosure.

FIG. 4b is an example illustrating a surrounding box according to the present disclosure.

FIG. 5 is a schematic flowchart illustrating a correlation-predicting according to the present disclosure.

FIG. 6 is a schematic diagram illustrating a method of predicting correlation according to the present disclosure.

FIG. 7 is a schematic flowchart illustrating a scheme of training a target detection model and a correlation prediction model according to an example of the present disclosure.

FIG. 8 is a schematic structural diagram illustrating an apparatus for predicting correlation between objects involved in an image according to the present disclosure.

FIG. 9 is a schematic diagram illustrating a hardware structure of an electronic device according to the present disclosure.

### DETAILED DESCRIPTION OF THE EMBODIMENTS

Exemplary embodiments will be described in detail here with the examples thereof expressed in the drawings. Where the following descriptions involve the drawings, like numerals in different drawings refer to like or similar elements unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

The terms used in the present disclosure are for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein is and includes any and all possible combinations of one or more of the associated listed items. It should also be understood that the term “if” as used herein may be interpreted as “when”, “while”, or “in response to determining”, depending on the context.

The present disclosure intends to disclose methods of predicting correlation between objects involved in an image. According to the methods, a first weighted feature and a second weighted feature of a target region are obtained by performing weighted-processing on the target region respectively based on first weight information of a first object with respect to the target region and second weight information of a second object with respect to the target region. Then, a correlation between the first object and the second object within the target region is predicted based on the first weighted feature and the second weighted feature.

Thus, on one hand, during predicting the correlation between a first object and a second object, feature information contained in the target region that is useful for predicting the correlation is introduced, and thereby improving an accuracy of the prediction result.

On the other hand, during predicting the correlation between the first object and the second object, by a weighting mechanism, feature information contained in the target region that is useful for predicting the correlation is strengthened while useless feature information is weakened, and thereby improving the accuracy of the prediction result.

It should be noted that the useful feature information contained in the target region may include feature information about other body parts besides the first object and the second object. For example, in a tabletop game scenario, the useful feature information includes, but is not limited to, feature information corresponding to said other body parts such as elbow, shoulder, upper arm, forearm, and neck.

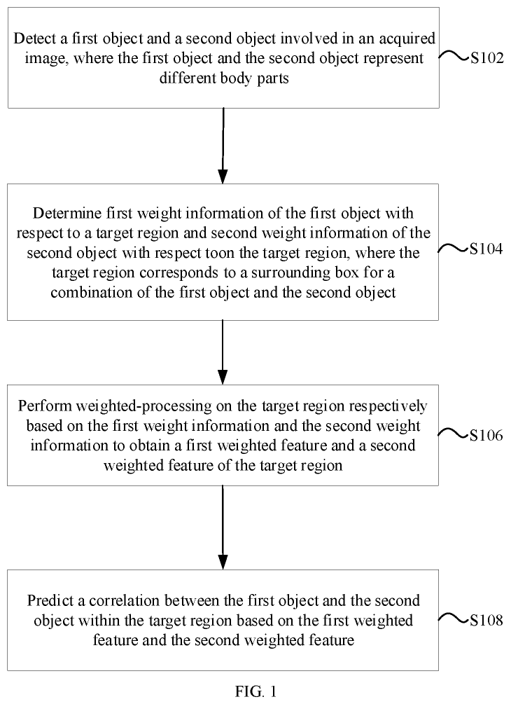

Referring to FIG. 1, FIG. 1 is a method flowchart illustrating a method of predicting correlation between objects involved in an image according to the present disclosure. As shown in FIG. 1, the method may include the following steps.

At S102, a first object and a second object involved in an acquired image are detected, where the first object and the second object represent different body parts.

At S104, first weight information of the first object with respect to a target region and second weight information of the second object with respect to the target region are determined, where the target region corresponds to a surrounding box for a combination of the first object and the second object.

At S106, weighted-processing is performed on the target region respectively based on the first weight information and the second weight information to obtain a first weighted feature and a second weighted feature of the target region.

At S108, a correlation between the first object and the second object within the target region is predicted based on the first weighted feature and the second weighted feature.

The method of predicting correlation may be applied to an electronic device. In particular, the electronic device may perform the method of predicting correlation through a software system corresponding to the method of predicting correlation. In one or more embodiments of the present disclosure, the electronic device may be a notebook, a computer, a server, a mobile phone, a PAD terminal, and the like, whose type is not particularly limited in the present disclosure.

It should be understood that the method of predicting correlation may be performed only by a terminal device or a server device alone, or may be performed in cooperation by the terminal device and the server device.

For example, the method of predicting correlation may be integrated into a client. The terminal device equipped with the client can perform the method through computational power provided by its own hardware environment after receiving a correlation prediction request.

As another example, the method of predicting correlation may be integrated into a system platform. The server device equipped with the system platform can perform the method through computational power provided by its own hardware environment after receiving the correlation prediction request.

As another example, the method of predicting correlation may be divided into two tasks: acquiring the image and processing the image. In particular, the task of acquiring the image may be performed by the client device, and the task of processing the image may be performed by the server device. The client device may initiate the correlation prediction request to the server device after acquiring the image. After receiving the request, the server device may perform the method of predicting correlation in response to the request.

In one or more examples in conjunction with the desktop game scenario, with the electronic device (hereinafter referred to as device) taken as an executor, some embodiments are described as follows.

In the desktop game scenario, for example, a hand object and a face object are taken respectively as the first object and the second object whose correlation is to be predicted. It should be understood that the description of the examples in this desktop game scenario provided by the present disclosure may be also serve as a reference for implementations in other scenarios, which is not described in detail here.

In the desktop game scenario, there is usually a game table. Game participants may surround the game table. In this desktop game scenario, image capture equipment may be deployed to capture one or more images of this desktop game scenario. The images from this scenario may include faces and hands of the game participants. In this scenario, it is expected to determine each hand and each face occurred in the image from this scenario that form correlated objects with each other, so that based on one face with which one hand occurred in the image is correlated, the identity of the person to whom the hand belongs can be identified.

Here, the expression that the hand and the face form the correlated objects with each other, or that the hand is correlated with the face, means that both of them, the hand and the face, belong to a same body, that is, they are the hand and the face of one person.

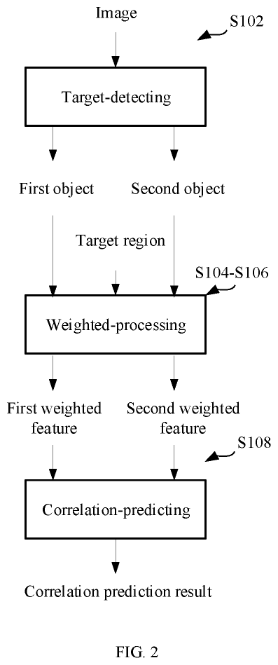

Referring to FIG. 2, FIG. 2 is a schematic flowchart illustrating a method of predicting correlation between objects involved in an image according to the present disclosure.

The image shown in FIG. 2, which may specifically be an image to be processed, may be acquired by image capture equipment deployed in a scenario to be detected. In particular, the image may come from several frames in a video stream captured by the image capture equipment, and may include several objects to be detected. For example, in a desktop game scenario, the image may be captured by the image capture equipment deployed in this scenario. The image from this scenario includes faces and hands of game participants.

In some embodiments, the device may interact with a user to complete inputting the image. For example, the device may provide a user interface by utilizing an interface carried by it. The user interface is used for the user to input images, like the image to be processed. Thus, the user can complete inputting the image via the user interface.

Still referring to FIG. 2, the S102 described above, may be performed after the device acquires the image, that is, the first object and the second object involved in the acquired image are detected.

The first object and the second object may represent different body parts. In particular, the first object and the second object may respectively represent any two different parts of the body such as a face, a hand, a shoulder, an elbow, an arm, and the like.

The first object and the second object may be taken as targets to be detected, and a trained target detection model may be utilized to process the image to obtain a result of detecting the first object and the second object.

In the desktop game scenario, the first object may be, for example, a face object, and the second object may be, for example, a hand object. The image may be input into a trained face-hand detection model, so as to detect the face object and the hand object involved in the image.

It should be understood that the result of a target-detecting for the image may include a bounding box for the first object and a bounding box for the second object. The mathematical representations of each bounding box include coordinates of at least one vertex and length-width information of the bounding box.

The target detection model may specifically be a deep convolutional neural network model configured to perform target-detecting tasks. For example, the target detection model may be a neural network model constructed based on a Region Convolutional Neural Network (RCNN), a Fast Region Convolutional Neural Network (FAST-RCNN) or a Faster Region Convolutional Neural Network (FASTER-RCNN).

In practical applications, before performing the target-detecting by utilizing the target detection model, the model may be trained based on several training samples with position information of the bounding boxes of the first object and the second object until the model is converged.

Referring to FIG. 3, FIG. 3 is a schematic flowchart illustrating the target-detecting according to the present disclosure. It should be noted that FIG. 3 only schematically illustrates a process of the target-detecting, but does not intend to specifically limit the present disclosure.

As shown in FIG. 3, the target detection model may be the FASTER-RCNN model. The model may include at least a backbone network, a Region Proposal Network (RPN), and a Region-based Convolutional Neural Network (RCNN).

In one or more embodiments, the backbone network may perform several convolution operations on the image to obtain a target feature map corresponding to the image. After being obtained, the target feature map may be inputted into the RPN network to obtain anchors corresponding to various target objects included in the image. After being obtained, the anchors, together with the target feature map, may be inputted into the corresponding RCNN network for bounding boxes (bbox) regression and classification, so as to obtain the bounding boxes respectively corresponding to the face objects and the hand objects contained in the image.

It should be noted that the solutions of the embodiments may employ a same target detection model to detect the body parts of two different types and for each target object involved in the image, and to annotate its type and its location individually during training. Thus, the target detection model may output the results of detecting the body parts of different types when performing the target-detecting task.

After determining the bounding boxes respectively corresponding to the first object and the second object, the S104-S106 may be performed. In particular, the first weight information of the first object with respect to the target region and the second weight information of the second object with respect to the target region are determined. The target region corresponds to the surrounding box for the combination of the first object and the second object. The weighted-processing is performed on the target region respectively based on the first weight information and the second weight information to obtain the first weighted feature and the second weighted feature of the target region.

The target region may be determined first before performing the S104. The following describes how to determine the target region.

In particular, the target region corresponds to the surrounding box for the combination of the first object and the second object. For example, in the desktop game scenario, the target region covers the surrounding box for the combination of the first object and the second object, and its area is not smaller than that of the surrounding box for the combination of the first object and the second object.

In some embodiments, the target region may be enclosed by the outline of the image. Then, the region enclosed by the outline of the image may be directly determined as the target region.

In some embodiments, the target region may be a certain local region of the image.

Illustratively, in the desktop game scenario, it is possible to determine the surrounding box for a combination of the face object and the face object, and then determine the region enclosed by the surrounding box as the target region.

The surrounding box specifically refers to a closed frame surrounding the first object and the second object. The shape of the surrounding box may be a circle, an ellipse, a rectangle, etc., and is not particularly limited here. The following description takes the rectangle as an example.

In some embodiments, the surrounding box may be a closed frame having no intersection with the bounding boxes corresponding to the first object and the second object.

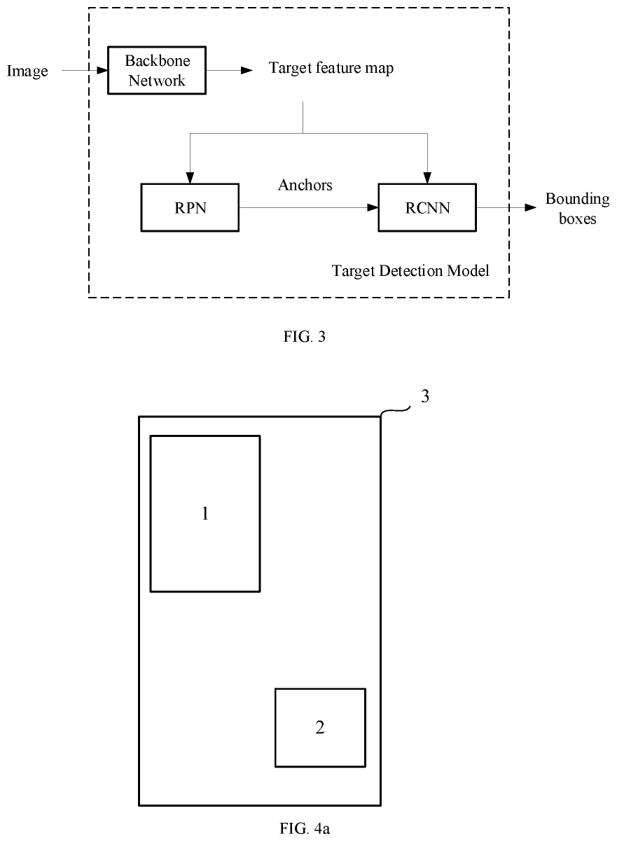

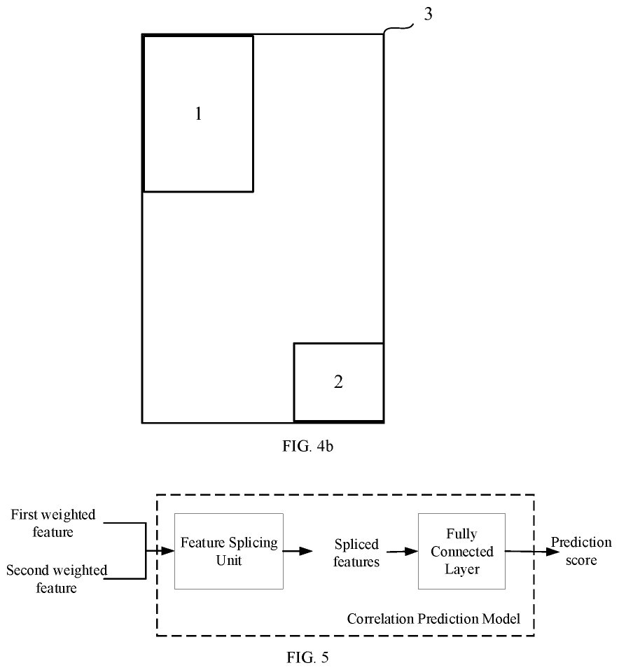

Referring to FIG. 4a, FIG. 4a an example illustrating a surrounding box according to the present disclosure.

As shown in FIG. 4a, the bounding box corresponding to the face object is box 1; the bounding box corresponding to the hand object is box 2; and the surrounding box for the combination of the face object and the hand object is box 3. In this example, the box 3 contains the box 1 and the box 2, and has no intersection with the box 1 or with the box 2.

In the above schemes of determining the surrounding box, on one hand, the surrounding box shown in FIG. 4a contains both the face object and the hand object. Thus, image features corresponding to the face object and the hand object, as well as features that are useful for predicting the correlation between the face object and the hand object, can be provided, thereby guaranteeing the accuracy of the prediction result for the correlation between the face object and the hand object.

On the other hand, the surrounding box shown in FIG. 4a surrounds the bounding boxes corresponding to the face object and the hand object. Thus, features corresponding to the bounding boxes may be introduced during predicting the correlation, thereby improving the accuracy of the correlation prediction result.

In some embodiments, based on the first bounding box corresponding to the face object and the second bounding box corresponding to the hand object, the surrounding box, which contains both the first bounding box and the second bounding box and has no intersections with the first bounding box or the second bounding box, may be acquired as the surrounding box for the face object and the hand object.

For example, position information of eight vertices corresponding to the first bounding box and the second bounding box may be taken. Then, based on the coordinate data of the eight vertices, the extreme values respectively on a horizontal coordinate and a vertical coordinate may be determined. If x represents the horizontal coordinate and y represents the vertical coordinate, the extreme values are Xₘᵢₙ, Xₘₐₓ, Yₘᵢₙ and Yₘₐₓ. Accordingly, by combining the minimum and maximum values on the horizontal coordinate respectively with the maximum and minimum values on the vertical coordinate, 4 vertex coordinates of an external-connecting frame of the first bounding box and the second bounding box may be obtained, i.e., (Xₘᵢₙ, Yₘᵢₙ), (Xₘᵢₙ, Yₘₐₓ), (Xₘₐₓ, Yₘᵢₙ), and (Xₘₐₓ, Yₘₐₓ). And then, position information respectively corresponding to 4 vertices of the surrounding box is to be determined based on a preset distance D between the external-connecting frame and the surrounding box. Thus, once determining the position information corresponding to the 4 vertices of the surrounding box, a rectangle outline determined by the 4 vertices may be determined as the surrounding box.

It should be understood that the image may include a plurality of face objects and a plurality of hand objects, which may form a plurality of “face-hand” combinations, and for each combination, its corresponding surrounding box may be determined individually.

In particular, by combining the various face objects with the various hand objects included in the image arbitrarily, all possible combinations of the body part objects are obtained and for each combination of the body part objects, its corresponding surrounding box is determined based on the positions of the face object and the hand object in the combination.

In some embodiments, the surrounding box may be a closed frame that is externally connected with the first bounding box and/or the second bounding box.

Referring to FIG. 4b, FIG. 4b is an example illustrating a surrounding box according to the present disclosure.

As shown in FIG. 4b, the bounding box corresponding to the face object is box 1; the bounding box corresponding to the hand object is box 2; and the surrounding box for the combination of the face object and the hand object is box 3. In this example, the box 3 contains the box 1 and the box 2, and touches some outer edges of both the box 1 and the box 2.

In the above scheme of determining the surrounding box, the surrounding box shown in FIG. 4b contains both the face object and the hand object, and the surrounding box is defined in size. On one hand, by controlling the area size of the surrounding box, an amount of computational load can be controlled, thereby improving the efficiency of predicting the correlation. On the other hand, some features which are introduced into the surrounding box and are useless to predict the correlation may be weakened, thereby reducing an influence of the uncorrelated features on the accuracy of the correlation prediction result.

After determining the target region, it may proceed with performing the S104-S106. That is, the first weight information of the first object with respect to the target region and the second weight information of the second object with respect to the target region are determined. The target region corresponds to the surrounding box for the combination of the first object and the second object. The weighted-processing is performed on the target region respectively based on the first weight information and the second weight information to obtain the first weighted feature and the second weighted feature of the target region.

In some embodiments, the first weight information may be calculated by a convolutional neural network or its partial network layer based on the features of the first object, relative position features between the first object and the target region, and the features of the target region in the image. In a similar way, the second weight information may be calculated.

The first weight information and the second weight information respectively represent their influence on calculating regional features of the target region in which they are located. The regional features of the target region are configured to estimate the correlation between the two objects.

The first weighted feature means that the regional features corresponding to the target region correlated with the first object may be strengthened while those uncorrelated with the first object may be weakened. In these embodiments, the regional features represent the features of the region in which the corresponding object involved in the image is located, e.g., the region corresponding to the surrounding box for the objects involved in the image, such as a feature map and a pixel matrix of the region in which the object is located.

The second weighted feature means that the regional features corresponding to the target region correlated with the second object may be strengthened while those uncorrelated with the second object may be weakened.

An exemplary method of obtaining the first weighted feature and the second weighted feature through the steps of S104-S106 is described below.

In some embodiments, the first weight information may be determined based on a first feature map corresponding to the first object. The first weight information is configured to perform the weighted-processing on the regional features corresponding to the target region, so as to strengthen the regional features corresponding to the target region correlated with the first object.

In some embodiments, the first feature map of the first object may be determined by performing regional feature extracting on the region corresponding to the first object.

In some embodiments, the first bounding box corresponding to the first object and the target feature map corresponding to the image may be inputted into a neural network, so as to perform an image processing to obtain the first feature map. In particular, the neural network includes a region feature extracting unit for performing regional feature extracting. The region feature extracting unit may be a Region of Interest Align (ROI Align) unit or a Region of Interest Pooling (ROI Pooling) unit.

Then, the first feature map may be adjusted to a preset size to obtain the first weight information. In these embodiments, the first weight information may be characterized by image pixel values of the first feature map adjusted to the preset size. The preset size may be a value set based on experience, which is not particularly limited here.

In some embodiments, by performing operations on the first feature map, such as a sub-sampling, a sub-sampling after several convolutions, or several convolutions after a sub-sampling, a first convolution kernel may be obtained from the first weight information corresponding to the first feature map reduced to the preset size. In these embodiments, the sub-sampling may be an operation such as a maximum pooling and an average pooling.

After the first weight information is determined, it may be to perform regional feature extracting on the target region to obtain the feature map of the target region. Then, with the first convolution kernel that is constructed based on the first weight information, a convolution operation is performed on the feature map of the target region to obtain the first weighted feature.

It should be noted that the size of the first convolution kernel is not particularly limited in the present disclosure. The size of the first convolution kernel may be (2n+1)*(2n+1), with the n being a positive integer.

During performing the convolution, a stride of the convolution may be first determined, e.g., the stride is 1, and then, the convolution operation is performed on the feature map of the target region with the first convolution kernel to obtain the first weighted feature. In some embodiments, in order to keep the size of the feature map unchanged before and after the convolution, the pixels on the periphery of the feature map of the target region may be filled with a pixel value of 0 before the convolution operation.

It should be understood that the step of determining the second weighted feature may refer to the above steps of determining the first weighted feature, which is not described in detail here.

In some embodiments, the first weighted feature may also be obtained by multiplying the first feature map and the feature map of the target region. The second weighted feature may be obtained by multiplying the second feature map and the feature map of the target region.

It should be understood that, obtaining the weighted feature either based on the convolution operation or by multiplying the feature maps is to, in fact, adjust the pixel values of various pixels in the feature map of the target region by performing the weighted-processing with the first feature map and the second feature map as the weight information respectively, which strengthens the regional features corresponding to the target region correlated with the first object and the second object and weakens those uncorrelated with the first object and the second object, thereby strengthening the information useful for predicting the correlation between the first object and second object while weakening useless information, so as to improve the accuracy of the correlation prediction result.

Still referring to FIG. 2, the S108 may be performed after determining the first weighted feature and the second weighted feature, that is, the correlation between the first object and the second object within the target region is predicted based on the first weighted feature and the second weighted feature.

In some embodiments, third weighted feature may be obtained by summing the first weighted feature and the second weighted feature, and be normalized based on a softmax function to obtain corresponding correlation prediction score.

In some embodiments, predicting the correlation between the first object and the second object within the target region, specifically refers to predicting a credibility score on whether the first object and the second object belong to a same body object.

For example, in the desktop game scenario, the first weighted feature and the second weighted feature may be inputted into a trained correlation prediction model to predict the correlation between the first object and the second object within the target region.

The correlation prediction model may specifically be a model constructed based on the convolutional neural network. It should be understood that the prediction model may include a fully connected layer, and finally output a correlation prediction score. The fully connected layer may specifically be a calculating unit constructed based on a regression algorithm such as linear regression and least square regression. The calculating unit may perform a feature-mapping on the regional features to obtain corresponding correlation prediction score.

In practical applications, before performing the prediction, the correlation prediction model may be trained based on several training samples with annotation information on the correlation between the first object and the second object.

During constructing the training samples, it may be to acquire several original images first, randomly combine respective first objects with respective second objects included in the original images by utilizing an annotation tool to obtain a plurality of combinations, and then annotate the correlation between the first object and the second object within each combination. Taking the face object and the hand object as the first object and the second object respectively as an example, it may be annotated with 1 if the face object and the hand object in the combination are correlated, i.e., belong to one person, otherwise it may be annotated with 0. Or, during annotating the original images, it may be annotated with information about person objects to which respective face objects and respective hand objects belong, such as person identity, so as to determine whether there is the correlation between the face object and the hand object in each combination based on whether the information of the belonged person objects is identical.

Referring to FIG. 5, FIG. 5 is a schematic diagram illustrating a correlation-predicting according to the present disclosure.

Illustratively, the correlation prediction model shown in FIG. 5 may include a feature splicing unit and a fully connected layer.

The feature splicing unit is configured to merge the first weighted feature and the second weighted feature to obtain merged weighted feature.

In some embodiments, the first weighted feature and the second weighted feature may be merged by performing operations such as superposition, averaging after normalization, and the like.

Then, the merged weighted feature is inputted into the fully connected layer of the correlation prediction model to obtain the correlation prediction result.

It should be understood that in practical applications, a plurality of target regions may be determined based on the image. When the S108 is performed, each target region may be determined as the current target region in turn, and the correlation between the first object and the second object within the current target region may be predicted.

As a result, it is realized to predict the correlation between the first object and the second object within the target region.

During predicting the correlation between the first object and the second object in the above schemes, the feature information that is included in the target region and is useful for predicting the correlation is introduced, thereby improving the accuracy of the prediction result. On the other hand, during predicting the correlation between the face object and the hand object, it employs the weighting mechanism to strengthen the feature information contained in the target region that is useful for predicting the correlation and weaken the useless feature information, thereby improving the accuracy of the prediction result.

In some embodiments, in order to further improve the accuracy of the prediction result for the correlation between the first object and the second object, during predicting the correlation between the first object and the second object within the target region based on the first weighted feature and the second weighted feature, it may be to predict the correlation between the first object and the second object within the target region based on the first weighted feature, the second weighted feature, and any one or more of the first object, the second object, and the target region.

It should be understood that multiple feasible implementations are included in the above schemes, and all of the multiple feasible implementations are protected in the present disclosure. As an example, predicting the correlation between the first object and the second object within the target region based on the target region, the first weighted feature, and the second weighted feature are described below. It should be understood that the steps of other feasible implementations may be referred to the following description, which will not be repeated in the present disclosure.

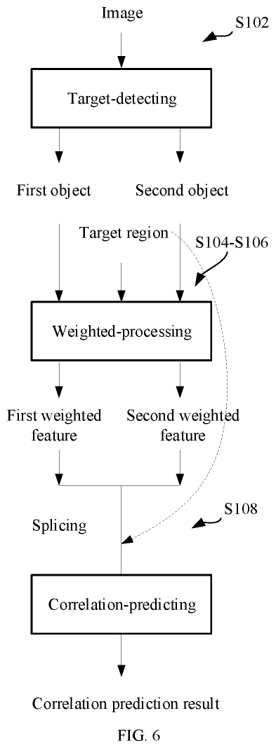

Referring to FIG. 6, FIG. 6 is a schematic diagram illustrating a method of predicting correlation according to the present disclosure.

As shown in FIG. 6, during performing the S108, a spliced feature may be obtained by performing feature splicing on the regional features corresponding to the target region, the first weighted feature, and the second weighted feature.

After the spliced feature is obtained, it may be to predict the correlation between the first object and the second object within the target region based on the spliced feature.

In some embodiments, the sub-sampling operation may be first performed on the spliced feature to obtain one-dimensional vector. After being obtained, the one-dimensional vector may be inputted into the fully connected layer for regression or classification, so as to obtain the correlation prediction score corresponding to the combination of the body parts, i.e., the first object and the second object.

In these embodiments, since the regional features of any one or more of the first object, the second object, and the target region are introduced and more diversified features associated with the first object and the second object are merged through the splicing, the influence of the information that is useful for predicting the correlation between the first object and the second object is strengthened in the correlation prediction, thereby further improving the accuracy of the prediction result for the correlation between the first object and the second object.

In some embodiments, the present disclosure also provides an example of a method. In the method, by employing the illustrated method of predicting correlation between objects involved in an image according to any one of the forgoing embodiments, it is first to predict the correlation between the first object and the second object within the target region determined based on the image. Then, based on the prediction result for the correlation between the first object and the second object within the target region, it is to determine correlated objects involved in the image.

In these embodiments, the correlation prediction scores may be utilized to represent the prediction result for the correlation between the first object and the second object.

It may also be further determined whether the correlation prediction score between the first object and the second object reaches a preset score threshold. If the correlation prediction score reaches the preset score threshold, it may be determined that the first object and the second object are the correlated objects involved in the image. Otherwise, it may be determined that the first object and the second object are not the correlated objects.

The preset score threshold is specifically an empirical threshold that may be set according to actual situations. For example, the preset standard value may be 0.95.

When the image includes a plurality of first objects and a plurality of second objects, during determining the correlated objects involved in the image, respective first objects and respective second objects detected from the image may be combined to obtain a plurality of combinations. Then, it is to determine a correlation prediction result corresponding to each of the plurality of combinations, such as a correlation prediction score.

In practical situations, typically, a face object corresponds to only two hand objects at most, and a hand object corresponds to only one face object at most.

In some embodiments, a current combination may be selected from respective combinations in a descending order of the correlation prediction scores of the respective combinations, and the following first step and second step may be performed.

At the first step, it is to count, based on the determined correlated objects, second determined objects that are correlated with the first object in the current combination and first determined objects that are correlated with the second object in the current combination, determine a first number of the second determined objects and a second number of the first determined objects, and determine whether the first number reaches a first preset threshold and whether the second number reaches a second preset threshold.

The first preset threshold is specifically an empirical threshold that may be set according to actual situations. For example, in the desktop game scenario, the first preset threshold may be 2 if the first object is the face object.

The second preset threshold is specifically an empirical threshold that may be set according to actual situations. For example, in the desktop game scenario, the second preset threshold may be 1 if the second object is the hand object.

In some embodiments, the current combination may be selected from the combinations whose correlation prediction scores reach a preset score threshold in the descending order of the correlation prediction scores.

In these embodiments, by determining the current combination from the combinations whose correlation prediction scores reach the preset score threshold, the combinations with lower correlation prediction scores may be eliminated, thereby reducing the number of the combinations to be further determined and improving the efficiency of determining the correlated objects.

In some embodiments, a counter may be maintained for each of respective first objects and respective second objects. Whenever a second object is determined to be correlated with any one first object, the value of the counter corresponding to the first object is added by 1. At this time, based on two counters, it may be determined whether the number of the second determined objects that are correlated with the first object in the current combination reaches the first preset threshold, and whether the number of the first determined objects that are correlated with the second object in the current combination reaches the second preset threshold. In some embodiments, the second determined objects include m second objects, and for the first object in the current combination and each of the m second objects, they have been determined to be correlated with each other, i.e., as the correlated objects, where the m may be equal to or greater than 0; the first determined objects include n first objects, and for the second object in the current combination and each of the n first objects, they have been determined to be correlated with each other, i.e., as the correlated objects, where the n may be equal to or greater than 0.

At the second step, in response to that the first number does not reach the first preset threshold and the second number does not reach the second preset threshold, the first object and the second object in the current combination are determined as the correlated objects involved in the image.

In the above schemes, in the case that the number of the second determined objects correlated with the first object included in the current combination does not reach the first preset threshold and the number of the first determined objects correlated with the second object included in the current combination does not reach the second preset threshold, the first object and the second object within the current combination are determined as the correlated objects. Thus, by employing the steps described in the above scheme in a complex scenario, e.g., a scenario with faces, limbs and hands overlapped, some unreasonable situations may be avoided from being predicted, such as the situation that one face object is correlated with more than two hand objects, and the situation that one hand object is correlated with more than one face object.

In some embodiments, the results of detecting the correlated objects involved in the image may be output.

In the desktop game scenario, the external-connecting frame containing one or more face objects and one or more hand objects indicated by the correlated objects may be output on image output equipment, for example, a display. By outputting the result of detecting the correlated objects on the image output equipment, an observer may conveniently and directly determine the correlated objects involved in the image displayed on the image output equipment, thereby facilitating further manual verification of the result of detecting the correlated objects.

The scheme of determining the correlated objects involved in the image illustrated in the present disclosure has been introduced in the above description, and training methods of various models used in the scheme are described below.

In some embodiments, the target detection model and the correlation prediction model may share the same backbone network.

In some embodiments, training sample sets for the target detection model and training sample sets for the correlation prediction model may be constructed separately, and the target detection model and the correlation prediction model may be trained respectively based on the constructed training sample sets.

In some embodiments, in order to improve the accuracy of the result of determining the correlated objects, the models may be trained in a segment-training way. In these embodiments, a first stage is to train the target detection model, and the second stage is to jointly train the target detection model and the correlation prediction model.

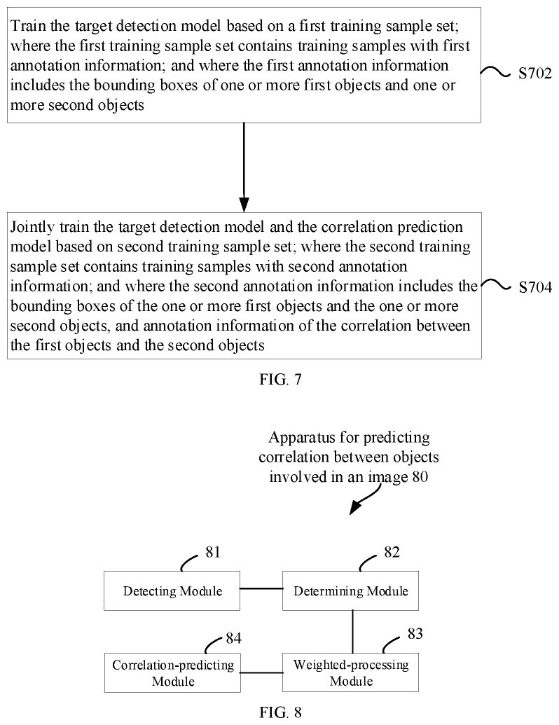

Refer to FIG. 7, it is a schematic flowchart illustrating a scheme of training the target detection model and the correlation prediction model according to an example of the present disclosure.

As shown in FIG. 7, the scheme includes the following steps.

At S702, the target detection model is trained based on a first training sample set; where the first training sample set contains training samples with first annotation information; and where the first annotation information includes the bounding boxes of one or more first objects and one or more second objects.

When performing this step, manual annotation or machine-assisted annotation may be employed to annotate the truth values of the original image. For example, in the desktop game scenario, after obtaining the original image, an image annotation tool may be utilized to annotate the bounding boxes of one or more face objects and one or more hand objects included in the original image, so as to obtain several training samples.

Then, the target detection model may be trained based on a preset loss function until the model is converged.

After the target detection model is converged, S704 may be performed, that is, the target detection model and the correlation prediction model are jointly trained based on second training sample set; where the second training sample set contains training samples with second annotation information; and where the second annotation information includes the bounding boxes of the one or more first objects and the one or more second objects, and annotation information of the correlation between the first objects and the second objects.

The manual annotation or the machine-assisted annotation may be employed to annotate the truth values of the original image. For example, in the desktop game scenario, after obtaining the original image, on one hand, the image annotation tool may be utilized to annotate the bounding boxes of the one or more face objects and the one or more hand objects included in the original image. On the other hand, the image annotation tool may be utilized to randomly combine each first object and each second object involved in the original image to obtain a plurality of combination results. Then, for the first object and the second object within each combination, their correlation is annotated to obtain correlation annotation information. In some embodiments, it may be annotated with 1 if the first object and the second object in a combination of body parts are the correlated objects, i.e., belong to one person, otherwise it may be annotated with 0.

After determining the second training sample set, a joint-learning loss function may be determined based on the loss functions respectively corresponding to the target detection model and the correlation prediction model.

In some embodiments, the joint-learning loss function may be obtained by calculating the sum or the weighted sum of the loss functions respectively corresponding to the target detection model and the correlation prediction model.

It should be noted that hyperparameters, such as regularization items, may also be added in the joint-learning loss function in the present disclosure. The types of the added hyperparameters are not particularly limited here.

The target detection model and the correlation prediction model may be jointly trained based on the joint-learning loss function and the second training sample set until the target detection model and the correlation prediction model are converged.

Since the supervised joint training scheme is employed for training the models, the target detection model and the correlation prediction model may be trained simultaneously. Accordingly, the training of the target detection model and the training of the correlation prediction model may be restricted and promoted with each other, so that it may increase the convergence efficiency of the two models on one hand, and promote the backbone network shared by the two models to extract more useful features for predicting the correlation on the other hand, thereby improving the accuracy of determining the correlated objects.

Corresponding to any one of the above embodiments, the present disclosure also provides apparatuses for predicting correlation between objects involved in an image. Referring to FIG. 8, FIG. 8 is a schematic structural diagram illustrating an apparatus for predicting correlation between objects involved in an image according to the present disclosure.

As shown in FIG. 8, the apparatus 80 includes:

a detecting module 81, configured to detect a first object and a second object involved in an acquired image, where the first object and the second object represent different body parts;

a determining module 82, configured to determine first weight information of the first object with respect to a target region and second weight information of the second object with respect to the target region, where the target region corresponds to a surrounding box for a combination of the first object and the second object;

a weighted-processing module 83, configured to preform weighted-processing on the target region respectively based on the first weight information and the second weight information to obtain a first weighted feature and a second weighted feature of the target region; and

a correlation-predicting module 84, configured to predict a correlation between the first object and the second object within the target region based on the first weighted feature and the second weighted feature.

In some embodiments, the apparatus 80 further includes a surrounding box determining module configured to: determine, based on a first bounding box for the first object and a second bounding box for the second object, a box that covers the first bounding box and the second bounding box but has no intersection with the first bounding box and the second bounding box as the surrounding box; or, determine, based on the first bounding box for the first object and the second bounding box for the second object, a box that covers the first bounding box and the second bounding box and is externally connected with the first bounding box and/or the second bounding box as the surrounding box.

In some embodiments, the determining module 82 is configured to: perform regional feature extracting on a region corresponding to the first object to determine a first feature map of the first object; perform regional feature extracting on a region corresponding to the second object to determine a second feature map of the second object; obtain the first weight information by adjusting the first feature map to a preset size, and obtain the second weight information by adjusting the second feature map to the preset size.

In some embodiments, the weighted-processing module 83 is configured to: perform regional feature extracting on the target region to determine a feature map of the target region; perform a convolution operation, with a first convolution kernel that is constructed based on the first weight information, on the feature map of the target region to obtain the first weighted feature; and perform a convolution operation, with a second convolution kernel that is constructed based on the second weight information, on the feature map of the target region to obtain the second weighted feature.

In some embodiments, the correlation-predicting module 84 includes: a correlation-predicting submodule, configured to predict the correlation between the first object and the second object within the target region based on the first weighted feature, the second weighted feature, and any one or more of the first object, the second object, and the target region.

In some embodiments, the correlation-predicting submodule is further configured to: obtain a spliced feature by performing feature splicing on the first weighted feature, the second weighted feature, and respective regional features of any one or more of the first object, the second object, and the target region; and predict the correlation between the first object and the second object within the target region based on the spliced feature.

In some embodiments, the apparatus 80 further includes: a correlated objects determining module, configured to determine, based on a prediction result for the correlation between the first object and the second object within the target region, correlated objects involved in the image.

In some embodiments, the apparatus 80 further includes: a combining module, configured to combine respective first objects and respective second objects detected from the image to generate a plurality of combinations, where each of the combinations includes one first object and one second object. Accordingly, the correlation-predicting module 84 is specifically configured to: determine a correlation prediction result for each of the plurality of combinations, where the correlation prediction result includes a correlation prediction score; select a current combination from respective combinations in a descending order of the correlation prediction scores of the respective combinations; and for the current combination: count, based on the determined correlated objects, second determined objects that are correlated with the first object in the current combination and first determined objects that are correlated with the second object in the current combination; determine a first number of the second determined objects and a second number of the first determined objects; and in response to that the first number does not reach a first preset threshold and the second number does not reach a second preset threshold, determine the first object and the second object in the current combination as correlated objects involved in the image.

In some embodiments, the correlation-predicting module 84 is specifically configured to: select, from the combinations whose correlation prediction scores reach a preset score threshold, the current combination in the descending order of the correlation prediction scores.

In some embodiments, the apparatus 80 further includes: an outputting module, is configured to output a detection result of the correlated objects involved in the image.

In some embodiments, the first object includes a face object; and the second object includes a hand object.

In some embodiments, the apparatus 80 further includes: a first training module, configured to train, based on a first training sample set, a target detection model; where the first training sample set contains training samples with first annotation information; and where the first annotation information includes the bounding box for the first object and the bounding box for the second object; and a joint training module, configured to train, based on a second training sample set, the target detection model and a correlation prediction model jointly; where the second training sample set contains training samples with second annotation information; and where the second annotation information includes the bounding box for the first object, the bounding box for the second object, and annotation information of the correlation between the first object and the second object; where the target detection model is configured to detect the first object and the second object involved in the image, and the correlation prediction model is configured to predict the correlation between the first object and the second object involved in the image.

The embodiments of the apparatuses for predicting correlation between objects involved in an image illustrated in the present disclosure may be applied to an electronic device. Correspondingly, the present disclosure provides an electronic device, which may include a processor, and a memory for storing executable instructions by the processor. The processor may be configured to call the executable instructions stored in the memory to implement the method of predicting correlation between objects involved in an image as illustrated in any one of the above embodiments.

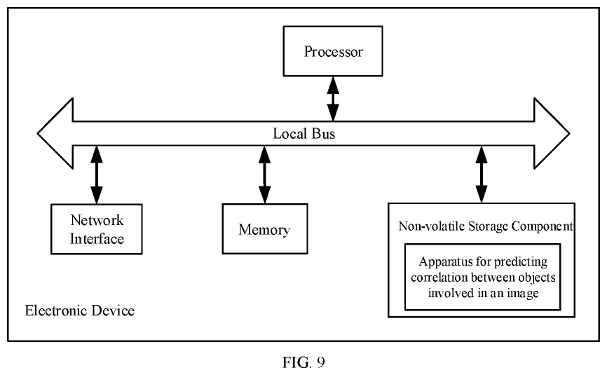

Referring to FIG. 9, FIG. 9 is a schematic diagram illustrating a hardware structure of an electronic device according to the present disclosure.

As shown in FIG. 9, the electronic device may include a processor for executing instructions, a network interface for network connection, a memory for storing operating data for the processor, and a non-volatile storage component for storing instructions corresponding to any one apparatus for predicting correlation.

In the electronic device, the embodiments of the apparatus for predicting correlation between objects involved in an image may be implemented by software, hardware or a combination thereof. Taking being implemented by software as an example, it is to form a logical apparatus by the processor of the electronic device in which the apparatus is located reading the corresponding computer program instructions from the non-volatile storage component into the memory and running. From a hardware perspective, in one or more embodiments, in addition to the processor, the memory, the network interface, and the non-volatile storage component shown in FIG. 9, the electronic device in which the apparatus is located may usually include other hardware based on any actual function of the electronic device, which will not be repeated here.

It should be understood that, in order to speed processing, the instructions corresponding to the apparatus for predicting correlation between objects involved in an image may also be directly stored in the memory, which is not limited here.

The present disclosure provides a computer-readable storage medium having a computer program stored thereon, and the computer program is configured to execute the method of predicting correlation between objects involved in an image illustrated according to any one of the foregoing embodiments.

Those skilled in the art should understand that the one or more embodiments of the present disclosure may be provided as methods, systems, or computer program products. Therefore, one or more embodiments of the present disclosure may be implemented as complete hardware embodiments, complete software embodiments, or embodiments combining software and hardware. Moreover, one or more embodiments of the present disclosure may be implemented in a form of a computer-program product that is executed on a computer-usable storage medium containing computer-usable program codes, which may include, but is not limited to a disk storage component, a CD-ROM, an optical storage component, etc.

The term “and/or” in the present disclosure means having at least one of two candidates, for example, A and/or B may include three cases: A alone, B alone, and both A and B.

Various embodiments in the present description are described in a progressive manner, the emphasizing description of each embodiment is different from the other embodiments, and the same or similar parts between various embodiments may be referred to each other. Especially, since substantially similar to the method embodiments, the electronic device embodiments are simply described and a reference may be made to part of its descriptions of the method embodiments for the related part.

The foregoing describes specific embodiments of the present disclosure. Other embodiments are within the scope of the appended claims. In some cases, it may still achieve the expected result even though the actions or steps described in the claims are performed in a different order than in the embodiments. In addition, it may still achieve the expected result even though the process described in the drawing does not follow its specific order or its successive order as shown. In some embodiments, multi-task processing or parallel processing is also feasible, or may be beneficial.

The embodiments of the subject matters and the functional operations described in the present disclosure may be implemented in: a digital electronic circuit, a tangible computer software or firmware, a computer hardware that may include a structure disclosed in the present disclosure and its structural equivalent, or a combination of one or more of them. The embodiments of the subject matters described in the present disclosure may be implemented as one or more computer programs, that is, one or more modules of computer program instructions which are encoded on a tangible non-transitory program carrier for being executed by data processing equipment or controlling operations of the data processing equipment. Alternatively or in addition, the program instructions may be encoded in artificial propagated signals, such as machine-generated electrical, optical, or electromagnetic signals, which are generated to encode and transmit information to suitable receiving equipment for being executed by the data processing equipment. The computer storage medium may be a machine-readable storage device, a machine-readable storage substrate, a random or serial access storage device, or a combination of one or more of them.

The processing and logic procedure described in the present disclosure may be executed by one or more programmable computers executing one or more computer programs, so as to operate based on the input data and generate the output to perform corresponding functions. The processing and logic procedure may also be executed by a dedicated logic circuit, such as a Field Programmable Gate Array (FPGA) or an Application Specific Integrated Circuit (ASIC), and the apparatus 80 may also be implemented as a dedicated logic circuit.

A computer suitable for executing the computer programs may include, for example, a general-purpose and/or special-purpose microprocessor, or any other type of central processing unit. Generally, the central processing unit receives instructions and data from a read-only storage component and/or a random access storage component. The basic components of the computer may include the central processing unit for implementing or executing the instructions and one or more storage devices for storing instructions and data. Generally, a computer also may include one or more mass storage devices for storing data. The mass storage devices may be, for example, magnetic, optical or magnetic-optical disks. Or, the computer may be operationally coupled to the mass storage devices for receiving data from or transmitting data to them. Or else, the above two cases may coexist. However, such devices are not necessary for the computer. In addition, the computer may be embedded into another device, such as a mobile phone, a personal digital assistant (PDA), a mobile audio or video player, a game console, a global positioning system (GPS) receiver, or a portable storage device, e.g., a universal serial bus (USB) Flash drive, which are mentioned only as a few examples.

The computer-readable medium suitable for storing the computer program instructions and the data may include all forms of a non-volatile storage component, a medium, and a storage device. For example, it may include a semiconductor storage device such as an EPROM, an EEPROM and a flash device, a magnetic disk such as an internal hard disk or a removable disk, a magnetic-optical disk, a CD ROM disk or a DVD-ROM disk. The processor and the memory may be supplemented by or incorporated into a dedicated logic circuit.

Although the present disclosure contains many specific implementation details, these should not be construed as limiting any scope to be disclosed or to be protected, but are mainly used to describe the features of specific disclosed embodiments. Certain features described in multiple embodiments of the present disclosure may also be combined and implemented in a single embodiment. On the other hand, various features described in a single embodiment can also be implemented separately in multiple embodiments or in any suitable sub-combination. In addition, although some features work in certain combinations as described above and even are initially claimed as such, one or more features from the claimed combination may be removed from it in some cases, and the claimed combination may refer to a sub-combination or its variant.

Similarly, although the operations are described in the drawings in a specific order, it should not be construed to mean that the operations have to be performed based on the shown specific order in turn, sequentially, or completely, to achieve the expected result. In some cases, multi-task or parallel processing may be beneficial. In addition, the separation of various system modules and components in the above embodiments should not be construed to mean that such separation is necessary in all embodiments. Moreover, it should be understood that the described program components and systems may usually be integrated together into a single software product, or packaged into multiple software products.

Thus, specific embodiments of the subject matter have been described. Other embodiments are fall within the scope of the appended claims. In some cases, the actions recited in the claims may be performed in a different order and still achieve the expected result. In addition, for the processing described in the drawings, it is not necessary to follow its specific order or sequential order as shown to achieve the expected result. In some implementations, multi-task or parallel processing may be beneficial.

The above are only preferred examples of one or more embodiments of the present disclosure, and are not used to limit the one or more embodiments of the present disclosure. Any modification, equivalent replacement, improvement, etc. within the spirit and principle of the one or more embodiments of the present disclosure shall be contained in the protection scope of the one or more embodiments of the present disclosure.

1. A method of predicting correlation between objects involved in an image, comprising:
detecting a first object and a second object involved in an acquired image, wherein the first object and the second object represent different body parts;
determining first weight information of the first object with respect to a target region and second weight information of the second object with respect to the target region, wherein the target region corresponds to a surrounding box for a combination of the first object and the second object;
performing weighted-processing on the target region respectively based on the first weight information and the second weight information to obtain a first weighted feature and a second weighted feature of the target region; and
predicting a correlation between the first object and the second object within the target region based on the first weighted feature and the second weighted feature.

2. The method according to claim 1, wherein the method further comprises:
determining, based on a first bounding box for the first object and a second bounding box for the second object, a box that covers the first bounding box and the second bounding box but has no intersection with the first bounding box and the second bounding box as the surrounding box; or,
determining, based on the first bounding box for the first object and the second bounding box for the second object, a box that covers the first bounding box and the second bounding box and is externally connected with the first bounding box and/or the second bounding box as the surrounding box.

3. The method according to claim 1, wherein determining the first weight information of the first object with respect to the target region and the second weight information of the second object with respect to the target region comprises:
performing regional feature extracting on a region corresponding to the first object to determine a first feature map of the first object;
performing regional feature extracting on a region corresponding to the second object to determine a second feature map of the second object;
obtaining the first weight information by adjusting the first feature map to a preset size, and
obtaining the second weight information by adjusting the second feature map to the preset size.

4. The method according to claim 1, wherein performing the weighted-processing on the target region respectively based on the first weight information and the second weight information to obtain the first weighted feature and the second weighted feature of the target region comprises:
performing regional feature extracting on the target region to determine a feature map of the target region;
performing a convolution operation, with a first convolution kernel that is constructed based on the first weight information, on the feature map of the target region to obtain the first weighted feature; and
performing a convolution operation, with a second convolution kernel that is constructed based on the second weight information, on the feature map of the target region to obtain the second weighted feature.

5. The method according to claim 1, wherein predicting the correlation between the first object and the second object within the target region based on the first weighted feature and the second weighted feature comprises:
predicting the correlation between the first object and the second object within the target region based on the first weighted feature, the second weighted feature, and any one or more of the first object, the second object, and the target region.

6. The method according to claim 5, wherein predicting the correlation between the first object and the second object within the target region based on the first weighted feature, the second weighted feature, and any one or more of the first object, the second object, and the target region comprises:
obtaining a spliced feature by performing feature splicing on the first weighted feature, the second weighted feature, and respective regional features of any one or more of the first object, the second object, and the target region; and
predicting the correlation between the first object and the second object within the target region based on the spliced feature.

7. The method according to claim 1, further comprising:
determining, based on a prediction result for the correlation between the first object and the second object within the target region, correlated objects involved in the image.

8. The method according to claim 7, wherein
the method further comprises:
combining respective first objects and respective second objects detected from the image to generate a plurality of combinations, wherein each of the combinations comprises one first object and one second object; and
determining, based on the prediction result for the correlation between the first object and the second object within the target region, correlated objects involved in the image comprises:
determining a correlation prediction result for each of the plurality of combinations, wherein the correlation prediction result comprise a correlation prediction score;
selecting a current combination from respective combinations in a descending order of the correlation prediction scores of the respective combinations; and
for the current combination:
counting, based on the determined correlated objects, second determined objects that are correlated with the first object in the current combination and first determined objects that are correlated with the second object in the current combination;
determining a first number of the second determined objects and a second number of the first determined objects; and
in response to that the first number does not reach a first preset threshold and the second number does not reach a second preset threshold, determining the first object and the second object in the current combination as correlated objects involved in the image.

9. The method according to claim 8, wherein selecting the current combination from the respective combinations in the descending order of the correlation prediction scores of the respective combinations comprises:
selecting, from the combinations whose correlation prediction scores reach a preset score threshold, the current combination in the descending order of the correlation prediction scores.

10. The method according to claim 7, further comprising:
outputting a detection result of the correlated objects involved in the image.

11. The method according to claim 1, wherein the first object comprises a face object; and the second object comprises a hand object.

12. The method according to claim 1, further comprising:
training, based on a first training sample set, a target detection model; wherein the first training sample set contains training samples with first annotation information; and wherein the first annotation information comprises a bounding box for the first object and a bounding box for the second object; and
training, based on a second training sample set, the target detection model and a correlation prediction model jointly; wherein the second training sample set contains training samples with second annotation information; and wherein the second annotation information comprises the bounding box for the first object, the bounding box for the second object, and annotation information of the correlation between the first object and the second object;
wherein the target detection model is configured to detect the first object and the second object involved in the image, and the correlation prediction model is configured to predict the correlation between the first object and the second object involved in the image.

13. An electronic device, comprising:
at least one processor; and
one or more memories coupled to the at least one processor and storing programming instructions for execution by the at least one processor to perform operations comprising:
detecting a first object and a second object involved in an acquired image, wherein the first object and the second object represent different body parts;
determining first weight information of the first object with respect to a target region and second weight information of the second object with respect to the target region, wherein the target region corresponds to a surrounding box for a combination of the first object and the second object;
performing weighted-processing on the target region respectively based on the first weight information and the second weight information to obtain a first weighted feature and a second weighted feature of the target region; and
predicting a correlation between the first object and the second object within the target region based on the first weighted feature and the second weighted feature.

14. The electronic device according to claim 13, the operations further comprising:
determining, based on a first bounding box for the first object and a second bounding box for the second object, a box that covers the first bounding box and the second bounding box but has no intersection with the first bounding box and the second bounding box as the surrounding box; or,
determining, based on the first bounding box for the first object and the second bounding box for the second object, a box that covers the first bounding box and the second bounding box and is externally connected with the first bounding box and/or the second bounding box as the surrounding box.

15. The electronic device according to claim 13, wherein determining the first weight information of the first object with respect to the target region and the second weight information of the second object with respect to the target region comprises:
performing regional feature extracting on a region corresponding to the first object to determine a first feature map of the first object;
performing regional feature extracting on a region corresponding to the second object to determine a second feature map of the second object;
obtaining the first weight information by adjusting the first feature map to a preset size, and
obtaining the second weight information by adjusting the second feature map to the preset size.

16. The electronic device according to claim 13, wherein performing the weighted-processing on the target region respectively based on the first weight information and the second weight information to obtain the first weighted feature and the second weighted feature of the target region comprises:
performing regional feature extracting on the target region to determine a feature map of the target region;
performing a convolution operation, with a first convolution kernel that is constructed based on the first weight information, on the feature map of the target region to obtain the first weighted feature; and
performing a convolution operation, with a second convolution kernel that is constructed based on the second weight information, on the feature map of the target region to obtain the second weighted feature.

17. The electronic device according to claim 13, wherein predicting the correlation between the first object and the second object within the target region based on the first weighted feature and the second weighted feature comprises:
predicting the correlation between the first object and the second object within the target region based on the first weighted feature, the second weighted feature, and any one or more of the first object, the second object, and the target region.

18. The electronic device according to claim 17, wherein predicting the correlation between the first object and the second object within the target region based on the first weighted feature, the second weighted feature, and any one or more of the first object, the second object, and the target region comprises:
obtaining a spliced feature by performing feature splicing on the first weighted feature, the second weighted feature, and respective regional features of any one or more of the first object, the second object, and the target region; and
predicting the correlation between the first object and the second object within the target region based on the spliced feature.

19. The electronic device according to claim 13, the operations further comprising:
determining, based on a prediction result for the correlation between the first object and the second object within the target region, correlated objects involved in the image.

20. A non-transitory computer-readable storage medium coupled to at least one processor and storing programming instructions for execution by the at least one processor to:
detect a first object and a second object involved in an acquired image, wherein the first object and the second object represent different body parts;
determine first weight information of the first object with respect to a target region and second weight information of the second object with respect to the target region, wherein the target region corresponds to a surrounding box for a combination of the first object and the second object;
perform weighted-processing on the target region respectively based on the first weight information and the second weight information to obtain a first weighted feature and a second weighted feature of the target region; and
predict a correlation between the first object and the second object within the target region based on the first weighted feature and the second weighted feature.
